(19) United States
(12) Patent Application Publication
(10) Pub. No.: US 2013/0195206 A1
(43) Pub. Date: Aug. 1, 2013

(54) VIDEO CODING USING EYE TRACKING MAPS

(71) Applicant: Sean T. McCarthy, San Francisco, CA (US)

(72) Inventor: Sean T. McCarthy, San Francisco, CA (US)

(73) Assignee: GENERAL INSTRUMENT CORPORATION, Horsham, PA (US)

(21) Appl. No.: 13/362,529

(22) Filed: Jan. 31, 2012

(51) Int. Cl. H04N 7/26

(52) U.S. Cl. 375/240.27; 375/E07.026

(57) ABSTRACT

Video, including a sequence of original pictures, is encoded using eye tracking maps. The original pictures are compressed. Perceptual representations, including the eye tracking maps, are generated from the original pictures and from the compressed original pictures. The perceptual representations generated from the original pictures and from the compressed original pictures are compared to determine video quality metrics. The video quality metrics may be used to optimize the encoding of the video and to generate metadata which may be used for transcoding or monitoring.

### BACKGROUND

Video encoding typically comprises compressing video through a combination of spatial image compression and temporal motion compensation. Video encoding is commonly used to transmit digital video via terrestrial broadcast, via cable TV, or via satellite TV services. Video compression is typically a lossy process that can cause degradation of video quality. Video quality is a measure of perceived video degradation, typically compared to the original video prior to compression.

A common goal for video compression is to minimize bandwidth for video transmission while maintaining video quality. A video encoder may be programmed to try to maintain a certain level of video quality so a user viewing the video after decoding is satisfied. An encoder may employ various video quality metrics to assess video quality. Peak Signal-to-Noise Ratio (PSNR) is one commonly used metric because it is unbiased in the sense that it measures fidelity without prejudice to the source of difference between reference and test pictures. Other examples of metrics include Mean Squared Error (MSE), Sum of Absolute Differences (SAD), Mean Absolute Difference (MAD), Sum of Squared Errors (SSE), and Sum of Absolute Transformed Differences (SATD).

Conventional video quality assessment, which may use one or more of the metrics described above, can be lacking for a variety of reasons. For example, video quality assessment based on fidelity is unselective for the kind of distortion in an image. For example, PSNR is unable to distinguish between distortions such as compression artifacts, noise, contrast difference, and blur. Existing structural and Human Visual System (HVS) video quality assessment methods may not be computationally simple enough to be incorporated economically into encoders and decoders. These weaknesses may result in inefficient encoding.

### BRIEF DESCRIPTION OF THE DRAWINGS

Features of the embodiments are apparent to those skilled in the art from the following description with reference to the figures, in which:

FIG. 1 illustrates a video encoding system, according to an embodiment;

FIG. 2 illustrates a video encoding system, according to another embodiment;

FIGS. 3A-B illustrate content distribution systems, according to embodiments;

FIG. 4 illustrates a process for generating perceptual representations from original pictures to encode a video signal, according to an embodiment;

FIG. 5 illustrates a comparison of sensitivity of correlation coefficients for perceptual representations and an original picture;

FIG. 6 illustrates examples of correlation coefficients and distortion types determined based on correlation coefficients;

FIG. 7 illustrates a video encoding method, according to an embodiment; and

FIG. 8 illustrates a computer system to provide a platform for systems described herein, according to an embodiment.

### SUMMARY

According to an embodiment, a system for encoding video includes an interface, an encoding unit and a perceptual engine module. The interface may receive a video signal including original pictures in a video sequence. The encoding unit may compress the original pictures. The perceptual engine module may perform the following: generate perceptual representations from the received original pictures and from the compressed original pictures, wherein the perceptual representations at least comprise eye tracking maps; compare the perceptual representations generated from the received original pictures and from the compressed original pictures; and determine video quality metrics from the comparison of the perceptual representations generated from the received original pictures and from the compressed original pictures.

According to another embodiment, a method for encoding video includes receiving a video signal including original pictures; compressing the original pictures; generating perceptual representations from the received original pictures and from the compressed original pictures, wherein the perceptual representations at least comprise eye tracking maps; comparing the perceptual representations generated from the received original pictures and from the compressed original pictures; and determining video quality metrics from the comparison of the perceptual representations generated from the received original pictures and from the compressed original pictures.

According to another embodiment, a video transcoding system includes an interface to receive encoded video and video quality metrics for the encoded video. The encoded video may be generated from perceptual representations from original pictures of the video and from compressed original pictures of the video, and the perceptual representations at least comprise eye tracking maps. The video quality metrics may be determined from a comparison of the perceptual representations generated from the original pictures and the compressed original pictures. The system also includes a transcoding unit to transcode the encoded video using the video quality metrics.

According to another embodiment, a method of video transcoding includes receiving encoded video and video quality metrics for the encoded video; and transcoding the encoded video using the video quality metrics. The encoded video may be generated from perceptual representations from original pictures of the video and from compressed original pictures of the video, and the perceptual representations at least comprise eye tracking maps. The video quality metrics may be determined from a comparison of the perceptual representations generated from the original pictures and the compressed original pictures.

### DETAILED DESCRIPTION

For simplicity and illustrative purposes, the present invention is described by referring mainly to embodiments and examples thereof. In the following description, numerous specific details are set forth in order to provide a thorough understanding of the examples. It is readily apparent however, that the present invention may be practiced without limitation to these specific details. In other instances, some methods and structures have not been described in detail so as not to unnecessarily obscure the description. Furthermore, different embodiments are described below. The embodiments may be used or performed together in different combinations.

According to an embodiment, video encoding system encodes video using perceptual representations. A perceptual representation is an estimation of human perception of regions, comprised of one or more pixels, in a picture, which may be a picture in a video sequence. Eye tracking maps are perceptual representations that may be generated from the pictures in the video sequence. An eye tracking map is an estimation of points of gaze by a human on the original pictures or estimations of movements of the points of gaze by a human on the original pictures. Original picture refers to a picture or frame in a video sequence before it is compressed. The eye tracking map may be considered a prediction of human visual attention on the regions of the picture. The eye tracking maps may be generated from an eye tracking model, which may be determined from experiments involving humans viewing pictures and measuring their points of gaze and movement of their gaze on different regions of the pictures.

The video encoding system may use eye tracking maps or other perceptual representations to improve compression efficiency, provide video quality metrics for downstream processing (e.g., transcoders & set top boxes), and monitoring and reporting. The video quality metrics can be integrated into the overall video processing pipeline to improve compression efficiency, and can be transmitted to other processing elements (such as transcoders) in the distribution chain to improve end-to-end efficiency.

The eye tracking maps can be used to define regions within an image that may be considered to be “features” and “texture”, and encoding of these regions is optimized. Also, fidelity and correlation between eye tracking maps provide a greater degree of sensitivity to visual difference than similar fidelity metrics applied to the original source images. Also, the eye tracking maps are relatively insensitive to changes in contrast, brightness, inversion, and other picture difference, thus providing a better metric of similarity between images. In addition, eye tracking maps and feature and texture classification of regions of the maps can be used in conjunction to provide multiple quality scores that inform as to the magnitude and effect of various types of distortions, including introduced compression artifacts, blur, added noise, etc.

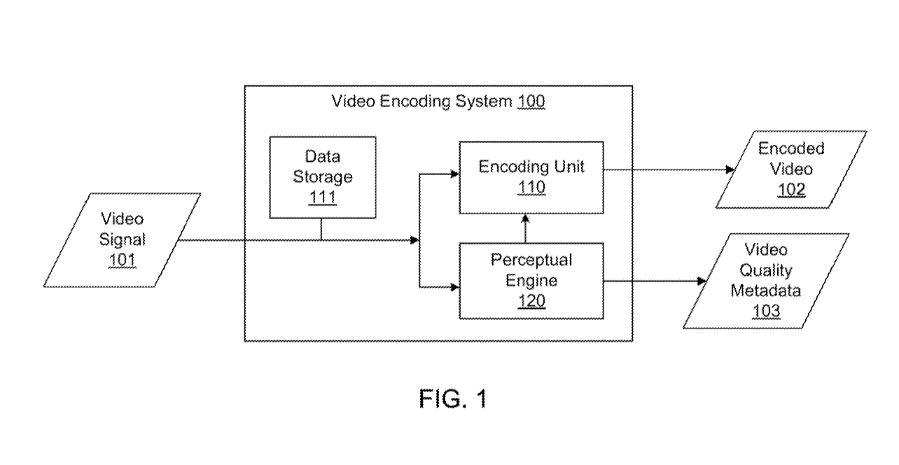

FIG. 1 illustrates a high-level block diagram of an encoding system 100 according to an embodiment. The video encoding system 100 receives a video sequence 101. The video sequence 101 may be included in a video bitstream and includes frames or pictures which may be stored for encoding.

The video encoding system 100 includes data storage 111 storing pictures from the video signal 101 and any other information that may be used for encoding. The video encoding system 100 also includes an encoding unit 110 and a perceptual engine 120. The perceptual engine 120 may be referred to as a perceptual engine module, which is comprised of hardware, software or a combination. The perceptual engine 120 generates perceptual representations, such as eye tracking maps and spatial detail maps, from the pictures in the video sequence 101. The perceptual engine 120 also performs block-based analysis and/or threshold operations to identify regions of each picture that may require more bits for encoding. The perceptual engine 120 generates video quality metadata 103 comprising one or more of video quality metrics, perceptual representations, estimations of distortion types and encoding parameters which may be modified based on distortion types. The video quality metadata 103 may be used for downstream encoding or transcoding and/or encoding performed by the encoding unit 110. Details on generation of the perceptual representations and the video quality metadata are further described below.

The encoding unit 110 encodes the pictures in the video sequence 101 to generate encoded video 102, which comprises a compressed video bitstream. Encoding may include motion compensation and spatial image compression. For example, the encoding unit generates motion vectors and predicted pictures according to a video encoding format, such as MPEG-2, MPEG-4 AVC, etc. Also, the encoding unit 110 may adjust encoding precision based on the video quality metadata and the perceptual representations generated by the perceptual engine 120. For example, certain regions of a picture identified by the perceptual engine 120 may require more bits for encoding and certain regions may use less bits for encoding to maintain video quality, as determined by the maps in the perceptual representations. The encoding unit 110 adjusts the encoding precision for the regions accordingly to improve encoding efficiency. The perceptual engine 120 also may generate video quality metadata 103 including video quality metrics according to perceptual representations generated for the encoded pictures. The video quality metadata may be included in or associated as metadata with the compressed video bitstream output by the video encoding system 100. The video quality metadata may be used for coding operations performed by other devices receiving the compressed video bitstream.

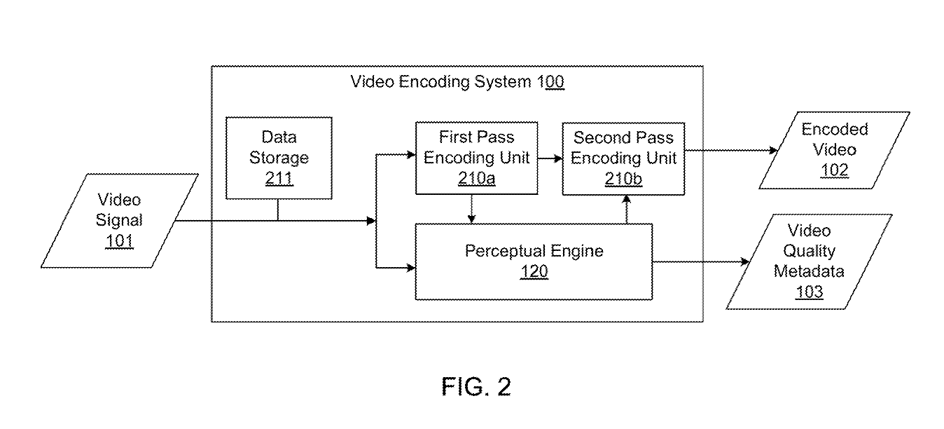

FIG. 2 shows an embodiment of the video encoding system 100 whereby the encoding unit 110 comprises a 2-pass encoder comprising a first-pass encoding unit 210a and second-pass encoding unit 210b. The first-pass encoding unit 210a compresses an original picture in the video signal 101 according to a video encoding format. The compressed picture is provided to the perceptual engine 120 and the second-pass encoding unit 210b. The perceptual engine 120 generates the video quality metadata 103 including video quality metrics according to perceptual representations generated for the original and compressed original. The perceptual engine 120 also provides an indication of regions to the second-pass encoding unit 210b. The indication of regions may include regions of the original picture that may require more bits for encoding to maintain video quality and/or regions that may use less bits for encoding while still maintaining video quality. The regions may include feature regions and texture regions described in further detail below. The second-pass encoding unit 210b adjusts the precision of the regions and outputs the encoded video 102.

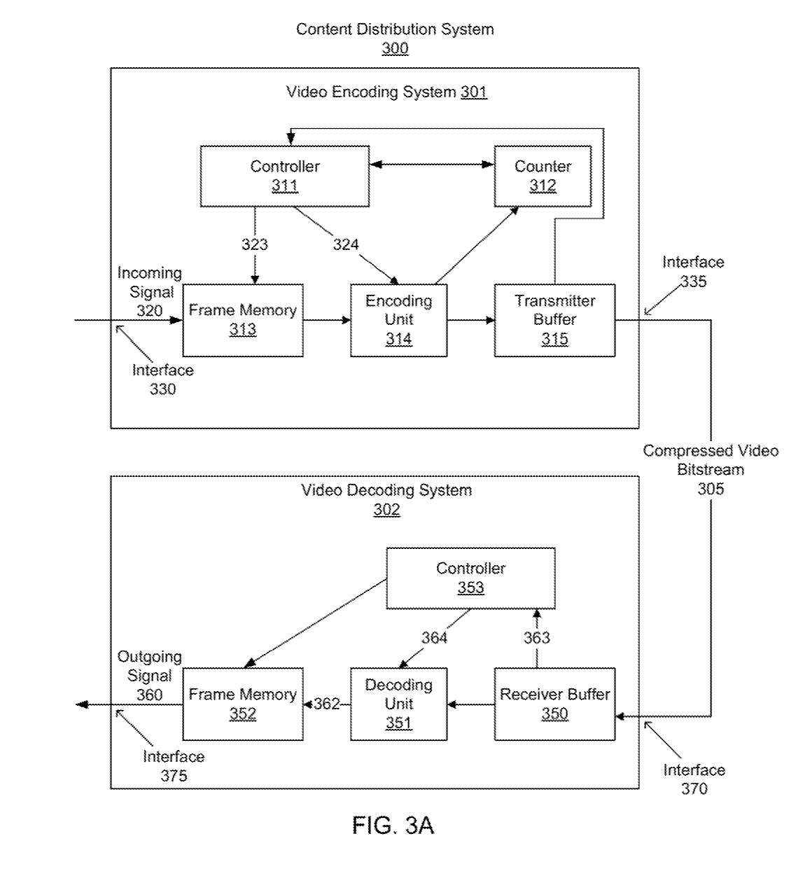

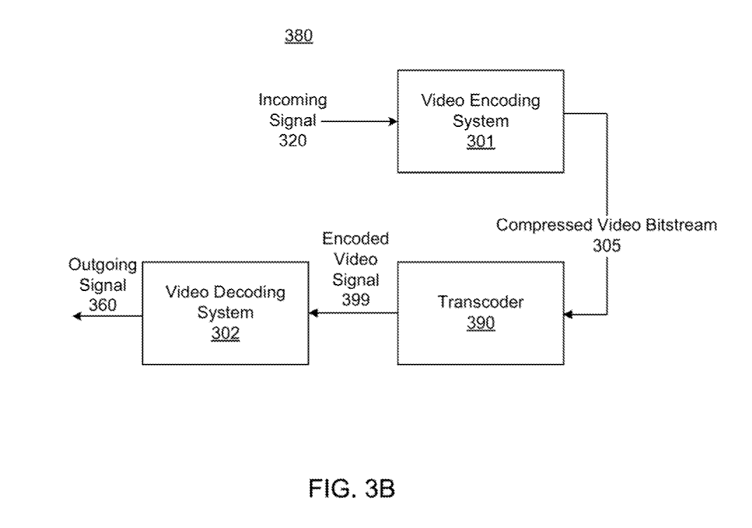

FIG. 3A illustrates a content distribution system 300 that comprises a video coding system, which may include a video encoding system 301 and a video decoding system 202. Video coding may include encoding, decoding, transcoding, etc. The video encoding system 301 includes a video encoding unit 314 that may include components of the video encoding system 100 shown in FIG. 1 or 2. The video encoding system 301 may be provided in any encoding system which may be utilized in compression or transcoding of a video sequence, including a headend. The video decoding system 302 may be provided in a set top box or other receiving device. The video encoding system 301 may transmit a compressed video bitstream 305, including motion vectors and other information, such as video quality metadata, associated with encoding utilizing perceptual representations, to the video decoding system 302.

The video encoding system 301 includes an interface 330 receiving an incoming signal 320, a controller 311, a counter 312, a frame memory 313, an encoding unit 314 that includes a perceptual engine, a transmitter buffer 315 and an interface 335 for transmitting the outgoing compressed video bitstream 305. The video decoding system 302 includes a receiver buffer 350, a decoding unit 351, a frame memory 352 and a controller 353. The video encoding system 301 and the video decoding system 302 are coupled to each other via a transmission path for the compressed video bitstream 305.

Referring to the video encoding system 301, the controller 311 of the video encoding system 301 may control the amount of data to be transmitted on the basis of the capacity of the receiver buffer 350 and may include other parameters such as the amount of data per unit of time. The controller 311 may control the encoding unit 314, to prevent the occurrence of a failure of a received signal decoding operation of the video decoding system 302. The controller 311 may include, for example, a microcomputer having a processor, a random access memory and a read only memory. The controller 311 may keep track of the amount of information in the transmitter buffer 315, for example, using counter 312. The amount of information in the transmitter buffer 315 may be used to determine the amount of data sent to the receiver buffer 350 to minimize overflow of the receiver buffer 350.

The incoming signal 320 supplied from, for example, a content provider may include frames or pictures in a video sequence, such as video sequence 101 shown in FIG. 1. The frame memory 313 may have a first area used for storing the pictures to be processed through the video encoding unit 314. Perceptual representations, motion vectors, predicted pictures and video quality metadata may be derived from the pictures in video sequence 101. A second area in frame memory 313 may be used for reading out the stored data and outputting it to the encoding unit 314. The controller 311 may output an area switching control signal 323 to the frame memory 313. The area switching control signal 323 may indicate whether data stored in the first area or the second area is to be used, that is, is to be provided to encoding unit 314 for encoding.

The controller 311 outputs an encoding control signal 324 to the encoding unit 314. The encoding control signal 324 causes the encoding unit 314 to start an encoding operation, such as described with respect to FIGS. 1 and 2. In response to the encoding control signal 324 from the controller 311, the encoding unit 314 generates compressed video and video quality metadata for storage in the transmitter buffer 315 and transmission to the video decoding system 302.

The encoding unit 314 may provide the encoded video compressed bitstream 305 in a packetized elementary stream (PES) including video packets and program information packets. The encoding unit 314 may map the compressed pictures into video packets using a program time stamp (PTS) and the control information. The encoded video compressed bitstream 305 may include the encoded video signal and metadata, such as encoding settings, perceptual representations, video quality metrics, or other information as further described below.

The video decoding system 302 includes an interface 370 for receiving the compressed video bitstream 305 and other information. As noted above, the video decoding system 302 also includes the receiver buffer 350, the controller 353, the frame memory 352, and the decoding unit 351. The video decoding system 302 further includes an interface 375 for output of the decoded outgoing signal 360. The receiver buffer 350 of the video decoding system 302 may temporarily store encoded information including motion vectors, residual pictures and video quality metadata from the video encoding system 301. The video decoding system 302, and in particular the receiver buffer 350, counts the amount of received data, and outputs a frame or picture number signal 363 which is applied to the controller 353. The controller 353 supervises the counted number of frames or pictures at a predetermined interval, for instance, each time the decoding unit 351 completes a decoding operation.

When the frame number signal 363 indicates the receiver buffer 350 is at a predetermined amount or capacity, the controller 353 may output a decoding start signal 364 to the decoding unit 351. When the frame number signal 363 indicates the receiver buffer 350 is at less than the predetermined capacity, the controller 353 waits for the occurrence of the situation in which the counted number of frames or pictures becomes equal to the predetermined amount. When the frame number signal 363 indicates the receiver buffer 350 is at the predetermined capacity, the controller 353 outputs the decoding start signal 364. The encoded frames, caption information and maps may be decoded in a monotonic order (i.e., increasing or decreasing) based on a presentation time stamp (PTS) in a header of program information packets.

In response to the decoding start signal 364, the decoding unit 351 may decode data, amounting to one frame or picture, from the receiver buffer 350. The decoding unit 351 writes a decoded video signal 362 into the frame memory 352. The frame memory 352 may have a first area into which the decoded video signal is written, and a second area used for reading out the decoded video data and outputting it as outgoing signal 360.

In one example, the video encoding system 301 may be incorporated or otherwise associated with an uplink encoding system, such as in a headend, and the video decoding system 302 may be incorporated or otherwise associated with a handset or set top box or other decoding system. These may be utilized separately or together in methods for encoding and/or decoding associated with utilizing perceptual representations based on original pictures in a video sequence. Various manners in which the encoding and the decoding may be implemented are described in greater detail below.

The video encoding unit 314 and associated perceptual engine module, in other embodiments, may not be included in the same unit that performs the initial encoding. The video encoding unit 314 may be provided in a separate device that receives an encoded video signal and perceptually encodes the video signal for transmission downstream to a decoder. Furthermore, the video encoding unit 314 may generate video quality metadata that can be used by downstream processing elements, such as a transcoder.

FIG. 3B illustrates a content distribution system 380 that is similar to the content distribution system 300 shown in FIG. 3A, except a transcoder 390 is shown as an intermediate device that receives the compressed video bitstream 305 from video encoding system 301 and transcodes the encoded video signal in the bitstream 305. The transcoder 390 may output an encoded video signal 399 which is then received and decoded by the video decoding system 302, such as described with respect to FIG. 3A. The transcoding may comprise re-encoding the video signal into a different MPEG format, a different frame rate, a different bitrate, or a different resolution. The transcoding may use the video quality metadata output from the video encoding system for transcoding. For example, the transcoding may use the metadata to identify and remove or minimize artifacts, blur and noise.

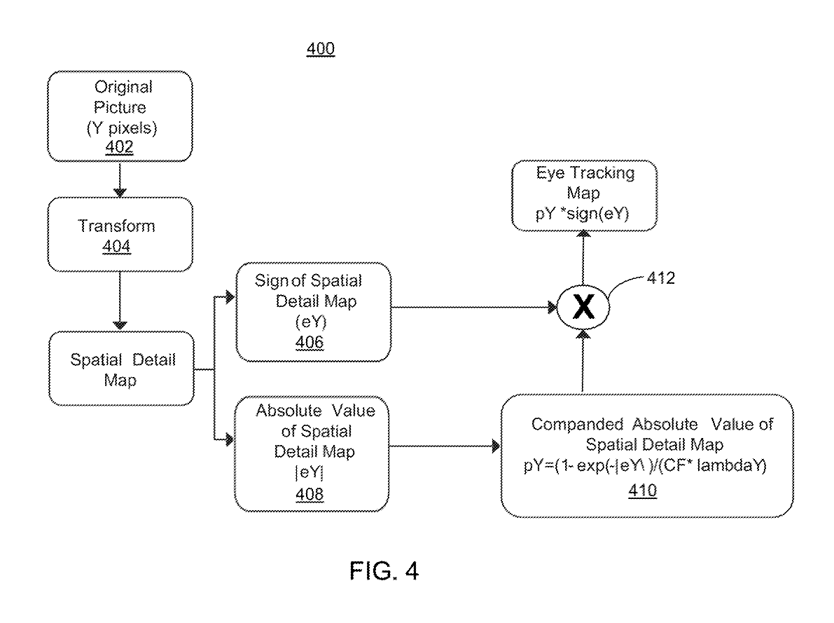

FIG. 4 depicts a process 400 that may be performed by a video encoding system 100, and in particular by the perceptual engine 120 of the video encoding system, for generating perceptual representations from original pictures. While the process 400 is described with respect to the video encoding system 100 described above, the process 400 may be performed in other video encoding systems, such as video encoding system 301, and in particular by a perceptual engine of the video encoding systems.

The process 400 begins when the original picture has a Y value assigned 402 to each pixel. For example, Y_{i,j} is the luma value of the pixel at coordinates i, j of an image having size M by N.

The Y pixel values are associated with the original picture. These Y values are transformed 404 to eY values in a spatial detail map. The spatial detail map may be created by the perceptual engine 120, using a model of the human visual system that takes into account the statistics of natural images and the response functions of cells in the retina. The model may comprise an eye tracking model. The spatial detail map may be a pixel map of the original picture based on the model.

According to an example, the eye tracking model associated with the human visual system includes an integrated perceptual guide (IPeG) transform. The IPeG transform for example generates an “uncertainty signal” associated with processing of data with a certain kind of expectable ensemble-average statistic, such as the scale-invariance of natural images. The IPeG transform models the eye tracking behavior of certain cell classes in the human retina. The IPeG transform can be achieved by 2D (two dimensional) spatial convolution followed by a summation step. Refinement of the approximate IPeG transform may be achieved by adding a low spatial frequency correction, which may itself be approximated by a decimation followed by an interpolation, or by other low pass spatial filtering. Pixel values provided in a computer file or provided from a scanning system may be provided to the IPeG transform to generate the spatial detail map. An IPeG system is described in more detail in U.S. Pat. No. 6,014,468 entitled “Apparatus and Methods for Image and Signal Processing,” issued Jan. 11, 2000; U.S. Pat. No. 6,360,021 entitled “Apparatus and Methods for Image and Signal Processing,” issued Mar. 19, 2002; U.S. Pat. No. 7,046,857 entitled “Apparatus and Methods for Image and Signal Processing,” a continuation of U.S. Pat. No. 6,360,021 issued May 16, 2006, and International Application PCT/US98/15767, entitled “Apparatus and Methods for Image and Signal Processing,” filed on Jan. 28, 2000, which are incorporated by reference in their entireties. The IPEG system provides information including a set of signals that organizes visual details into perceptual significance, and a metric that indicates an ability of a viewer to track certain video details.

The spatial detail map includes the values eY. For example, eY_{i,j} is a value at i, j of an IPEG transform of the Y value at i, j from the original picture. Each value eY_{i,j} may include a value or weight for each pixel identifying a level of difficulty for visual perception and/or a level of difficulty for compression. Each eY_{i,j} may be positive or negative.

As shown in FIG. 4, a sign of spatial detail map, e.g., sign (eY), and an absolute value of spatial detail map, e.g., |eY|, are generated 406, 408 from the spatial detail map. According to an example, sign information may be generated as follows:

$$sign ( e {Y}_{i , j} ) = \{ \begin{matrix}+ 1 , & for e {Y}_{i , j} > 0 \\ 0 , & for e {Y}_{i , j} = 0 \\ - 1 , & for e {Y}_{i , j} < 0\end{matrix}$$

According to another example, the absolute value of spatial detail map is calculated as follows: |eY_{i,j}| is the absolute value of eY_{i,j}.

A companded absolute value of spatial detail map, e.g., pY, is generated 410 from the absolute value of spatial detail map, |eY|. According to an example, companded absolute value information may be calculated as follows: pY_{i,j}=1−e^{-|eY}^{_{i,j}}^{|/(CF×λ}^{ᵣ}⁾, and

$${λ}_{Y} = \frac{{\sum }_{i = 1}^{M} {\sum }_{j = 1}^{N} \vert e {Y}_{i , j} \vert}{M \times N} ,$$

where CF (companding factor) is a constant provided by a user or system and where λ_{Y} is the overall mean absolute value of |eY_{i,j}|. The above equation is one example for calculating pY. Other functions, as known in the art, may be used to calculate pY. Also, CF may be adjusted to control contrast in the perceptual representation or adjust filters for encoding. In one example, CF may be adjusted by a user (e.g., weak, medium, high). “Companding” is a portmanteau word formed from “compression” and “expanding.” Companding describes a signal processing operation in which a set of values is mapped nonlinearly to another set of values typically followed by quantization, sometimes referred to as digitization. When the second set of values is subject to uniform quantization, the result is equivalent to a non-uniform quantization of the original set of values. Typically, companding operations result in a finer (more accurate) quantization of smaller original values and a coarser (less accurate) quantization of larger original values. Through experimentation, companding has been found to be a useful process in generating perceptual mapping functions for use in video processing and analysis, particularly when used in conjunction with IPeG transforms. pY_{i,j} is a nonlinear mapping of the eY_{i,j} values and the new set of values pY_{i,j} have a limited dynamic range. Mathematic expressions other than shown above may be used to produce similar nonlinear mappings between eY_{i,j} and pY_{i,j}. In some cases, it may be useful to further quantize the values, pY_{i,j}. Maintaining or reducing the number of bits used in calculations might be such a case.

The eye tracking map of the original picture may be generated 412 by combining the sign of the spatial detail map with the companded absolute value of the spatial detail map as follows: pY_{i,j}×sign(eY_{i,j}). The results of pY_{i,j}×sign(eY_{i,j}) is a compressed dynamic range in which small absolute values of eY_{i,j} occupy a preferentially greater portion of the dynamic range than larger absolute values of eY_{i,j}, but with the sign information of eY_{i,j} preserved.

Thus the perceptual engine 120 creates eye tracking maps for original pictures and compressed pictures so the eye tracking maps can be compared to identify potential distortion areas. Eye tracking maps may comprise pixel-by-pixel predictions for an original picture and a compressed picture generated from the original picture. The eye tracking maps may emphasize the most important pixels with respect to eye tracking. The perceptual engine may perform a pixel-by-pixel comparison of the eye tracking maps to identify regions of the original picture that are important. For example, the compressed picture eye tracking map may identify that block artifacts caused by compression in certain regions may draw the eye away from the original eye tracking pattern, or that less time may be spent observing background texture, which is blurred during compression, or that the eye may track differently in areas where strong attractors occur.

Correlation coefficients may be used as a video quality metric to compare the eye tracking maps for the original picture and the compressed picture. A correlation coefficient, referred to in statistics as R², is a measure of the quality of prediction of one set of data from another set of data or statistical model. It is describes the proportion of variability in a data set that is accounted for by the statistical model.

According to other embodiments, metrics such as Mean Squared Error (MSE), Sum of Absolute Differences (SAD), Mean Absolute Difference (MAD), Sum of Squared Errors (SSE), and Sum of Absolute Transformed Differences (SATD) may be used to compare the eye tracking maps for the original picture and the compressed picture.

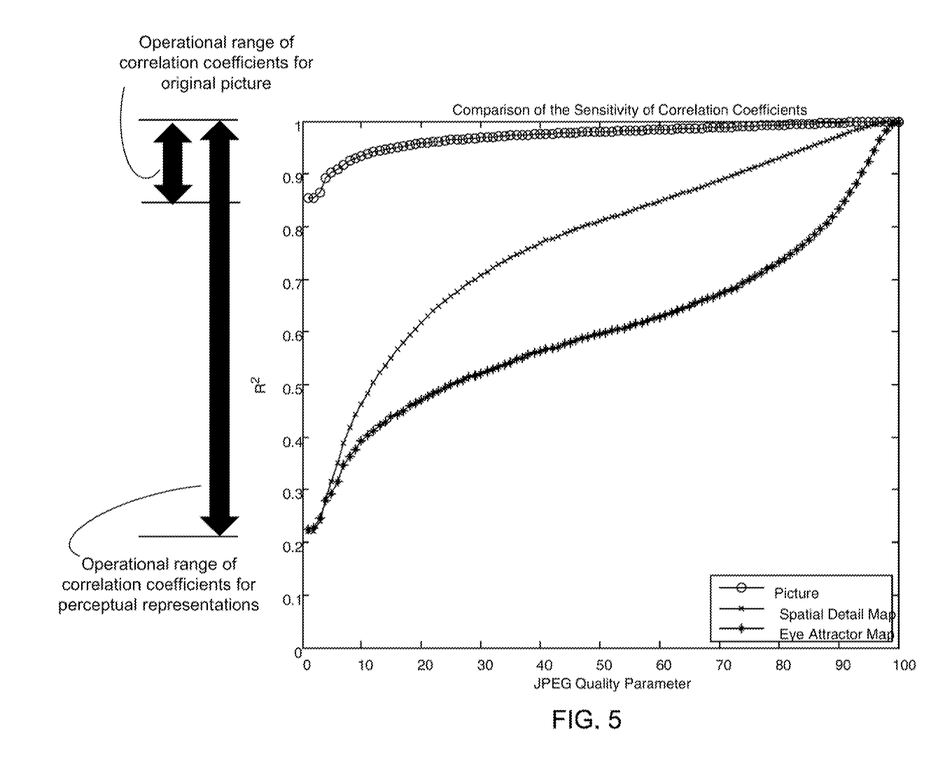

According to an embodiment, correlation coefficients are determined for the perceptual representations, such as eye tracking maps or spatial detail maps. For example, correlation coefficients may be determined from an original picture eye tracking map and compressed picture eye tracking map rather than from the original picture and the compressed picture. Referring now to FIG. 5, a graph is depicted that illustrates the different ranges of correlation coefficients for an original picture versus perceptual representations. The Y-axis (R²) of the graph represents correlation coefficients and the X-axis of the graph represents a quality metric, such as a JPEG quality parameter. For perceptual representations comprising a spatial detail map and an eye tracking map, the operational range and discriminating ability is much larger than the range for the original picture correlation coefficients. Thus, there is a much greater degree of sensitivity for quality metrics determined from the correlation coefficients, such as the JPEG quality parameter, which provides a much higher degree of quality discrimination.

Below is a description of equations for calculating correlation coefficients for the perceptual representations. Calculation of the correlation coefficients may be performed using the following equations:

$${R}^{2} = \frac{\text{?}}{\text{?}}$$

$$relative contrast = \frac{\text{?}}{\text{?}}$$

$$relative mean = \frac{\text{?}}{\text{?}}$$

$$\text{?} = {\sum }^{ } ( \text{?} - \text{?} ) ( \text{?} - \text{?} )$$

$$\text{?} = {\sum }^{ } ( \text{?} - \text{?} ) ( \text{?} - \text{?} )$$

$$\text{?} = {\sum }^{ } ( \text{?} - \text{?} ) ( \text{?} - \text{?} )$$

$$\text{?} {\sum }^{ } \frac{\text{?}}{\text{?}}$$

$$\text{?} \text{indicates text missing or illegible when filed}$$

R² is the correlation coefficient; I(i,j) may represent the value at each pixel i,j; Ī is the average value of the data ‘I’ over all pixels included in the summations; and SS is the sum of squares. The correlation coefficient may be calculated for luma values using I(i,j)=Y(i,j); for spatial detail values using I(i,j)=eY(i,j); for eye tracking map values using I(i,j)=pY(i,j) sign(eY(i,j)); and using I(i,j)=pY(i,j).

The perceptual engine 120 may use the eye tracking maps to classify regions of a picture as a feature or texture. A feature is a region determined to be a strong eye attractor, and texture is a region determined to be a low eye attractor. Classification of regions as a feature or texture may be determined based on a metric. The values pY, which is the companded absolute value of spatial detail map as described above, may be used to indicate if a pixel would likely be regarded by a viewer as belonging to a feature or texture: pixel locations having pY values closer to 1.0 than to 0.0 would be likely to be regarded as being associated with visual features, and pixel locations having pY values closer to 0.0 than to 1.0 would likely be regarded as being associated with textures.

After feature and texture regions are identified, correlation coefficients may be calculated for those regions. The following equations may be used to calculate the correlation coefficients:

$$\text{?} = \frac{\text{?}}{\text{?}}$$

$$\text{?} {\sum }^{ } ( \text{?} - \text{?} ) ( \text{?} - \text{?} ) \text{?}$$

$$\text{?} {= \sum }^{ } ( \text{?} - \text{?} ) ( \text{?} - \text{?} ) \text{?}$$

$$\text{?} {\sum }^{ } ( \text{?} - \text{?} ) ( \text{?} - \text{?} ) \text{?}$$

$$\text{?} \frac{\text{?}}{\text{?}}$$

$$\text{?} = {\sum }^{ } ( \text{?} - \text{?} ) ( \text{?} - \text{?} ) \text{?}$$

$$\text{?} = {\sum }^{ } ( \text{?} - \text{?} ) ( \text{?} - \text{?} ) \text{?}$$

$$\text{?} = {\sum }^{ } ( \text{?} - \text{?} ) ( \text{?} - \text{?} ) \text{?}$$

$$\text{?} \text{indicates text missing or illegible when filed}$$

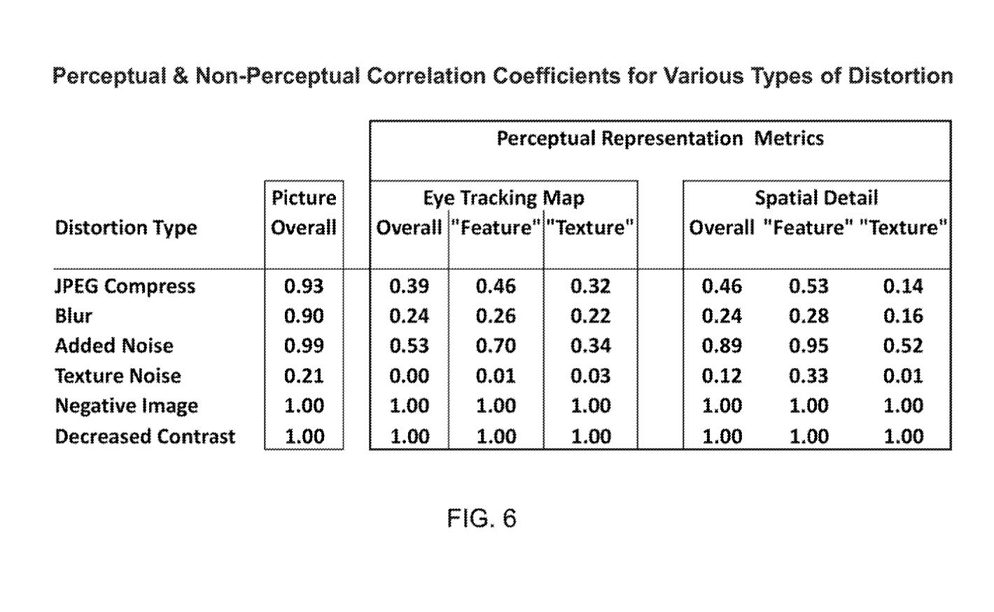

In the equations above, ‘HI’ refers to pixels in a feature region; ‘LO’ refers to pixels in a texture region. FIG. 6 shows examples of correlation coefficients calculated for original pictures and perceptual representations (e.g., eye tracking map, and spatial detail map) and feature and texture regions of the perceptual representations. In particular, FIG. 6 shows results for 6 test pictures each having a specific kind of introduced distortion: JPEG compression artifacts; spatial blur; added spatial noise; added spatial noise in regions likely to be regarded as texture; negative of the original image; and a version of the original image having decreased contrast. Correlation coefficients may be calculated for an entire picture, for a region of a picture such as a macroblock, or over a sequence of pictures. Correlation coefficients may also be calculated for discrete or overlapping spatial regions or temporal durations. Distortion types may be determined from the correlation coefficients. The picture overall column of FIG. 6 shows examples of correlation coefficients for an entire original picture. For the eye tracking map and the spatial detail map, a correlation coefficient is calculated for the entire map. Also, correlation coefficients are calculated for the feature regions and the texture regions of the maps. The correlation coefficients may be analyzed to identify distortion types. For example, flat scores across all the feature regions and texture regions may be caused by blur. If a correlation coefficient for a feature region is lower than the other correlation coefficients, then the perceptual engine may determine that there is noise in this region. Based on the type of distortion determined from the correlation coefficients, encoding parameters, such as bit rate or quantization parameters, may be modified to minimize distortion.

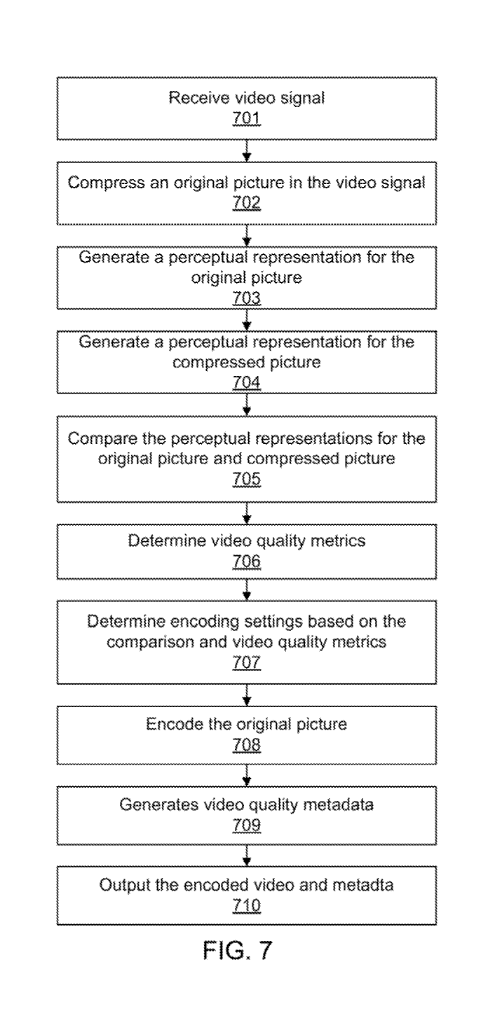

Referring now to FIG. 7, a logic flow diagram 700 is provided that depicts a method for encoding video according to an embodiment. The logic flow diagram 700 is described with respect to the video encoding system 100 described above, however, the method 700 may be performed in other video encoding systems, such as video encoding system 301.

At 701, a video signal is received. For example, the video sequence 101 shown in FIG. 1 is received by the encoding system 100. The video signal comprises a sequence of original pictures, which are to be encoded by the encoding system 100.

At 702, an original picture in the video signal is compressed. For example, the encoding unit 110 in FIG. 1 may compress the original picture using JPEG compression or another type of conventional compression standard. The encoding unit 110 may comprise a multi-pass encoding unit such as shown in FIG. 2, and a first pass may perform the compression and a second pass may encode the video.

At 703, a perceptual representation is generated for the original picture. For example, the perceptual engine 120 generates an eye tracking map and/or a spatial detail map for the original picture.

At 704, a perceptual representation is generated for the compressed picture. For example, the perceptual engine 120 generates an eye tracking map and/or a spatial detail map for the compressed original picture.

At 705, the perceptual representations for the original picture and the compressed picture are compared. For example, the perceptual engine 120 calculates correlation coefficients for the perceptual representations.

At 706, video quality metrics are determined from the comparison. For example, feature, texture, and overall correlation coefficients for the eye tracking map for each region (e.g., macroblock) of a picture may be calculated.

At 707, encoding settings are determined based on the comparison and video quality metrics determined at steps 705 and 706. For example, based on the perceptual representations determined for the original picture and the compressed image, the perceptual engine 120 identifies feature and texture regions of the original picture. Quantization parameters may be adjusted for these regions. For example, more bits may be used to encode feature regions and less bits may be used to encode texture regions. Also, an encoding setting may be adjusted to account for distortion, such as blur, artifact, noise, etc., identified from the correlation coefficients.

At 708, the encoding unit 110 encodes the original picture according to the encoding settings determined at step 707. The encoding unit 110 may encode the original picture and other pictures in the video signal using standard formats such as an MPEG format.

At 709, the encoding unit 110 generates metadata which may be used for downstream encoding operations. The metadata may include the video quality metrics, perceptual representations, estimations of distortion types and/or encoding settings.

At 710, the encoded video and metadata may be output from the video encoding system 100, for example, for transmission to custorner premises or intermediate coding systems in a content distribution system. The metadata may be generated at steps 706 and 707. Also, the metadata may not be transmitted from the video encoding system 100 if not needed. The method 700 is repeated for each original picture in the received video signal to generate an encoded video signal which is output from the video encoding system 100.

The encoded video signal, for example, generated from the method 700 may be decoded by a system, such as video decoding system 302, for playback by a user. The encoded video signal may also be transcoded by a system such as transcoder 390. For example, a transcoder may transcode the encoded video signal into a different MPEG format, a different frame rate or a different bitrate. The transcoding may use the metadata output from the video encoding system at step 710. For example, the transcoding may comprise re-encoding the video signal using the encoding setting described in steps 707 and 708. The transcoding may use the metadata to remove or minimize artifacts, blur and noise.

Some or all of the methods and operations described above may be provided as machine readable instructions, such as a utility, a computer program, etc., stored on a computer readable storage medium, which may be non-transitory such as hardware storage devices or other types of storage devices. For example, they may exist as program(s) comprised of program instructions in source code, object code, executable code or other formats.

An example of a computer readable storage media includes a conventional computer system RAM, ROM, EPROM, EEPROM, and magnetic or optical disks or tapes. Concrete examples of the foregoing include distribution of the programs on a CD ROM. It is therefore to be understood that any electronic device capable of executing the above-described functions may perform those functions enumerated above.

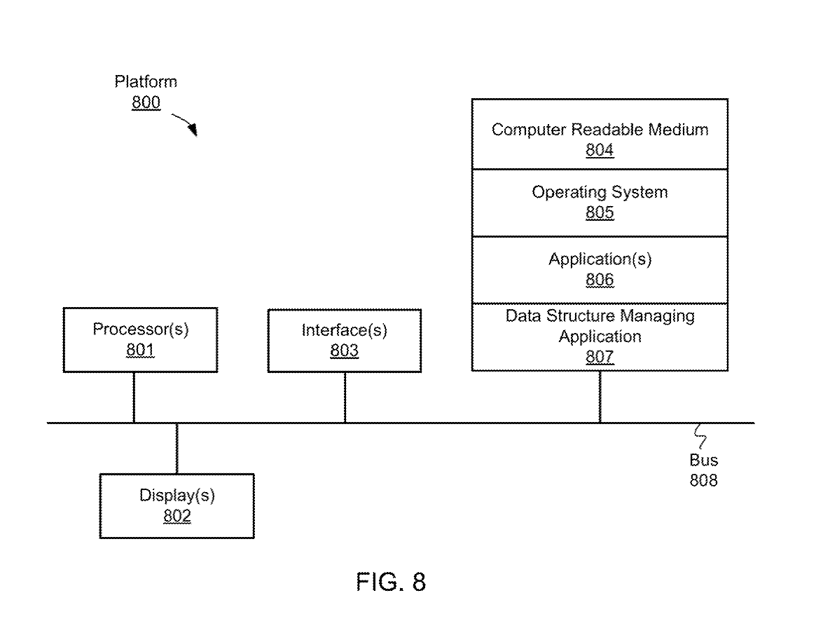

Referring now to FIG. 8, there is shown a platform 800, which may be employed as a computing device in a system for encoding or decoding or transcoding, such as the systems described above. The platform 800 may also be used for an encoding apparatus, such as a set top box, a mobile phone or other mobile device. It is understood that the illustration of the platform 800 is a generalized illustration and that the platform 800 may include additional components and that some of the components described may be removed and/or modified without departing from a scope of the platform 800.

The platform 800 includes processor(s) 801, such as a central processing unit; a display 802, such as a monitor; an interface 803, such as a simple input interface and/or a network interface to a Local Area Network (LAN), a wireless 802.11x LAN, a 3G or 4G mobile WAN or a WiMax WAN; and a computer-readable medium 804. Each of these components may be operatively coupled to a bus 808. For example, the bus 808 may be an EISA, a PCI, a USB, a FireWire, a NuBus, or a PDS.

A computer-readable medium (CRM), such as the CRM 804, may be any suitable medium which participates in providing instructions to the processor(s) 801 for execution. For example, the CRM 804 may be non-volatile media, such as a magnetic disk or solid-state non-volatile memory or volatile media. The CRM 804 may also store other instructions or instruction sets, including word processors, browsers, email, instant messaging, media players, and telephony code.

The CRM 804 also may store an operating system 805, such as MAC OS, MS WINDOWS, UNIX, or LINUX; applications 806, network applications, word processors, spreadsheet applications, browsers, email, instant messaging, media players such as games or mobile applications (e.g., “apps”); and a data structure managing application 807. The operating system 805 may be multi-user, multiprocessing, multitasking, multithreading, real-time-and the like. The operating system 805 also may perform basic tasks such as recognizing input from the interface 803, including from input devices, such as a keyboard or a keypad; sending output to the display 802, and keeping track of files and directories on the CRM 804; controlling peripheral devices, such as disk drives, printers, and an image capture device; and managing traffic on the bus 808. The applications 806 may include various components for establishing and maintaining network connections, such as code or instructions for implementing communication protocols including TCP/IP, HTTP, Ethernet, USB, and FireWire.

A data structure managing application, such as data structure managing application 807, provides various code components for building/updating a computer readable system (CRS) architecture, for a non-volatile memory, as described above. In certain examples, some or all of the processes performed by the data structure managing application 807 may be integrated into the operating system 805. In certain examples, the processes may be at least partially implemented in digital electronic circuitry, in computer hardware, firmware, code, instruction sets, or any combination thereof.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While embodiments have been described with reference to examples, those skilled in the art are able to make various modifications without departing from the scope of the embodiments as described in the following claims, and their equivalents.

What is claimed is:

1. A system for encoding video, the system comprising:
an interface to
receive a video signal including original pictures in a video sequence;
an encoding unit to
compress the original pictures; and
a perceptual engine module to
generate perceptual representations from the received original pictures and from the compressed original pictures, wherein the perceptual representations at least comprise eye tracking maps;
compare the perceptual representations generated from the received original pictures and from the compressed original pictures; and
determine video quality metrics from the comparison of the perceptual representations generated from the received original pictures and from the compressed original pictures.

2. The system of claim 1, wherein the encoding unit is to determine adjustments to encoding settings based on the video quality metrics; encode the original pictures using the adjustments to improve video quality; and output the encoded pictures.

3. The system of claim 1, wherein metadata, including the video quality metrics, is output from the system, and the metadata is operable to be used by a system receiving the outputted metadata to encode or transcode the original pictures.

4. The system of claim 1, wherein the perceptual engine module classifies regions of each original picture into texture regions and feature regions from the perceptual representations; compares each classified region in the original picture and the compressed picture; and, based on the comparison, determines the video quality metrics for each classified region.

5. The system of claim 4, wherein the perceptual engine module determines potential distortion types from the video quality metrics for each region.

6. The system of claim 1, wherein the perceptual representations comprise spatial detail maps.

7. The system of claim 1, wherein the perceptual engine module is configured to generate the perceptual representations by
generating spatial detail maps from the original pictures;
determining sign information for pixels in the spatial detail maps;
determining absolute value information for pixels in the spatial detail maps; and
processing the sign information and the absolute value information to form the eye tracking maps.

8. The system of claim 1, wherein the eye tracking maps comprise an estimation of points of gaze by a human on the original pictures or estimations of movements of the points of gaze by a human on the original pictures.

9. The system of claim 1, wherein the video quality metrics comprise correlation coefficients determined from values in the eye tracking maps for pixels.

10. A method for encoding video, the method comprising:
receiving a video signal including original pictures;
compressing the original pictures;
generating perceptual representations from the received original pictures and from the compressed original pictures, wherein the perceptual representations at least comprise eye tracking maps;
comparing the perceptual representations generated from the received original pictures and from the compressed original pictures; and
determining video quality metrics from the comparison of the perceptual representations generated from the received original pictures and from the compressed original pictures.

11. The method of claim 10, comprising:
determining adjustments to encoding settings based on the video quality metrics;
encoding the original pictures using the adjustments to improve video quality; and
outputting the encoded pictures.

12. The method of claim 11, comprising:
outputting metadata, including the video quality metrics, with the encoded pictures from a video encoding system, wherein the metadata is operable to be used by a system receiving the outputted metadata to encode or transcode the original pictures.

13. The method of claim 10, wherein determining video quality metrics comprises:
classifying regions of each original picture into texture regions and feature regions from the perceptual representations;
comparing each classified region in the original picture and the compressed picture; and
based on the comparison, determining the video quality metrics for each classified region.

14. The method of claim 13, comprising determining potential distortion types from the video quality metrics for each region.

15. The method of claim 10, wherein generating perceptual representations comprises:
generating spatial detail maps from the original pictures;
determining sign information for pixels in the spatial detail maps;
determining absolute value information for pixels in the spatial detail maps; and
processing the sign information and the absolute value information to form the eye tracking maps.

16. The method of claim 10, wherein the perceptual representations comprise spatial detail maps.

17. The method of claim 10, wherein the eye tracking maps comprise an estimation of points of gaze by a human on the original pictures or estimations of movements of the points of gaze by a human on the original pictures.

18. A non-transitory computer readable medium including machine readable instructions for executing the method of claim 10.

19. A video transcoding system comprising:
an interface to receive encoded video and video quality metrics for the encoded video,
wherein the encoded video is generated from perceptual representations from original pictures of the video and from compressed original pictures of the video, and the perceptual representations at least comprise eye tracking maps, and
wherein the video quality metrics are determined from a comparison of the perceptual representations generated from the original pictures and the compressed original pictures; and
a transcoding unit to transcode the encoded video using the video quality metrics.

20. A method of video transcoding comprising:
receiving encoded video and video quality metrics for the encoded video,
wherein the encoded video is generated from perceptual representations from original pictures of the video and from compressed original pictures of the video, and the perceptual representations at least comprise eye tracking maps, and
wherein the video quality metrics are determined from a comparison of the perceptual representations generated from the original pictures and the compressed original pictures; and
transcoding the encoded video using the video quality metrics.
